(19) United States
(12) Patent Application Publication
(10) Pub. No.: US 2022/0234289 A1
(43) Pub. Date: Jul. 28, 2022

(54) 3D PRINTED OBJECTS AND ENCLOSED CONTAINER STRUCTURES

(71) Applicant: Hewlett-Packard Development Company, L.P., Spring, TX (US)

(72) Inventors: William J. Allen, Corvallis, OR (US); Melanie Martin Citta, Palo Alto, CA (US); John C. Greeven, Corvallis, OR (US); Kristopher J. Erickson, Palo Alto, CA (US); Jarrid Wittkopf, Palo Alto, CA (US); Temiloluwa Adegoke, Corvallis, OR (US)

(73) Assignee: Hewlett-Packard Development Company, L.P., Spring, TX (US)

(21) Appl. No.: 17/417,130

(22) PCT Filed: Jul. 19, 2019
(86) PCT No.: PCT/US2019/042622

§ 371 Date: Jun. 22, 2021

(51) Int. Cl. B29C 64/188; B33Y 10/00; B33Y 30/00; B33Y 80/00; B29C 64/165

(52) U.S. Cl. CPC B29C 64/188; B33Y 10/00; B29L 2031/712; B33Y 80/00; B29C 64/165; B33Y 30/00

(57) ABSTRACT

In one example in accordance with the present disclosure, an additive manufacturing system is described. The additive manufacturing system includes an additive manufacturing device to form 1) a three-dimensional (3D) printed object and a container structure to form part of the 3D printed object. The container structure expels a payload when a predetermined condition is met. The additive manufacturing system also includes a payload distributor to place the payload in the container structure. A controller of the additive manufacturing system controls formation of the 3D printed object and the container structure.

### BACKGROUND

Additive manufacturing systems produce three-dimensional (3D) objects by building up layers of material. Some additive manufacturing systems are referred to as “3D printing devices” because they use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for forming 3D printed objects and 3D printed container structures, according to an example of the principles described herein.

FIG. 2 is a simplified top view of an additive manufacturing system for forming 3D printed objects and 3D printed container structures, according to an example of the principles described herein.

FIGS. 3A and 3B are side views of an additive manufacturing bed for forming 3D printed objects and 3D printed container structures, according to an example of the principles described herein.

FIG. 4 is an isometric view of a 3D printed container structure, according to an example of the principles described herein.

FIG. 5A is a cross section of a non-ruptured 3D printed container structure, according to an example of the principles described herein.

FIG. 5B is a cross section of a ruptured 3D printed container structure, according to an example of the principles described herein.

FIGS. 6A and 6B are cross sections of a 3D printed container structure, according to another example of the principles described herein.

FIG. 7 is a flow chart of a method for forming 3D printed objects and 3D printed container structures, according to an example of the principles described herein.

FIG. 8 is an isometric view of an array of 3D printed container structures in a 3D printed object, according to an example of the principles described herein.

FIGS. 9A and 9B depict a 3D printed container structure, according to an example of the principles described herein.

FIG. 10 depicts a 3D printed object with an array of 3D printed container structures, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of a build material. Additive manufacturing systems make objects based on data in a 3D model of the object generated, for example, with a computer-aided drafting (CAD) computer program product. The model data is processed into slices, each slice defining portions of a layer of build material that is to be solidified.

In one example, to form the 3D object, a build material, which may be powder, is deposited on a bed. A fusing agent is then dispensed onto portions of the layer of build material that are to be fused to form a layer of the 3D object. The system that carries out this type of additive manufacturing may be referred to as a powder and fusing agent-based system. The fusing agent disposed in the desired pattern increases the energy absorption of the layer of build material on which the agent is disposed. The build material is then exposed to energy such as electromagnetic radiation. The electromagnetic radiation may include infrared light, laser light, or other suitable electromagnetic radiation. Due to the increased heat absorption properties imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has increased energy absorption characteristics, fuses while that portion of the build material that has not received the fusing agent remains in powder form. Those portions of the build material that receive the agent and thus have increased heat absorption properties may be referred to as fused portions. By comparison, the applied heat is not so great so as to increase the heat of the portions of the build material that are free of the agent to this fusing temperature. Those portions of the build material that do not receive the agent and thus do not have increased heat absorption properties may be referred to as unfused portions.

Accordingly, a predetermined amount of heat is applied to an entire bed of build material, the portions of the build material that receive the fusing agent, due to the increased heat absorption properties imparted by the fusing agent, fuse and form the object while the unfused portions of the build material are unaffected, i.e., not fused, in the presence of such application of thermal energy. This process is repeated in a layer-wise fashion to generate a 3D object. The unfused portions of material can then be separated from the fused portions, and the unfused portions recycled for subsequent 3D formation operations.

Another way of 3D formation selectively applies binder to areas of loose build material. In this example, a “latent” part is prepared inside a build bed filled with build material. The build bed may be transferred to a furnace where a first heating step removes solvents present in the applied binder. As solvents are removed, the remaining binder hardens and glues together build material to convert the “latent” part into a “green” part. The green part is then removed from the bed. As a result of this operation, residual build material may be caked onto the green parts. It may be desirable to remove residual build material from green parts in a cleaning step. In some examples, the green parts are loaded into a sintering furnace where applied heat can cause binder decomposition and causes the build material powder particles to sinter or fuse together into a durable solid form.

In yet another example, a laser, or other power source is selectively aimed at a powder build material, or a layer of a powder build material, to form a slice of a 3D printed part. Such a process may be referred to as selective laser sintering. In yet another example, the additive manufacturing process may use selective laser melting where portions of the powder material, which may be metallic, are selectively melted together to form a slice of a 3D printed part. As yet another example, in fused deposition modeling melted build material is selectively deposited in a layer where it cools. As it cools it fuses together and adheres to a previous layer. This process is repeated to construct a 3D printed part.

In yet another example, the additive manufacturing process may involve using a light source to cure a liquid resin into a hard substance. Such an operation may be referred to as stereolithography. While such additive manufacturing operations have greatly expanded manufacturing and development possibilities, further development may make 3D printing a part of even more industries. Accordingly, a device which carries out any of these additive manufacturing processes may be referred to as an additive manufacturing device and in some cases a printer.

For example, the present specification describes a system and method to sequester a payload, such as unfused powder build material, inside shells of fused build material. This type of nodule can be thought of as an egg shell with powder trapped inside. Accordingly, upon rupture, or the application of a rupturing physical force, the payload of the shell is released. The payload may be of a variety of types. For example, the payload may be raw build material, doped build material, or even another material such as a liquid. In one particular example, the doped build material is a non-metallic build material doped with colorants. In yet another example, the payload may be a hardware structure such as a physical device such as a circuit board or other piece of electronic hardware. The container structure may be formed during the additive manufacturing process and the payload may be deposited therein also during the additive manufacturing process. The payload inside a container structure, after the additive manufacturing process, is released when certain conditions occur.

As one particular example, colored, or uncolored, unfused powder build material is enclosed in multiple container structures arranged in a planar matrix configuration as a small floormat. Upon application of pressure, for example by a foot stepping on the mat, container structures experiencing levels of pressure exceeding a designed threshold rupture, thus releasing the encapsulated unfused build material. This causes a visible change in the appearance of the mat in areas experiencing higher levels of applied pressure. The result is a visibly readable map of pressures over the bottom of a person's foot, when the individual is standing. While specific reference is made to a particular application, a large range of applications are enabled by the controlled release of the payload of a container structure, including, but not limited to: embedding information in parts, security, self-healing components, and a wide variety of sensors.

Specifically, the present specification describes an additive manufacturing system. The system includes an additive manufacturing device to form 1) a three-dimensional (3D) printed object and 2) a container structure to form part of the 3D printed object. The container structure expels a payload when a predetermined condition is met. The additive manufacturing system also includes a payload distributor to place the payload in the container structure and a controller to control formation of the 3D printed object and the container structure.

The present specification also describes a method. According to the method, slices of a 3D printed object are sequentially formed. A 3D printed container structure is also formed as part of the 3D printed object. The 3D printed container structure to expel a payload when predetermined conditions are met. In this example, the formation of the 3D printed object and the 3D printed container structure is interrupted to place the payload in the 3D printed container structure. Forming of slices of the 3D printed object is resumed to enclose the 3D printed container structure to capture the payload.

In another example, the additive manufacturing system includes a build material distributor to deposit layers of powdered build material onto a bed and an agent distributor. The agent distributor 1) forms a 3D printed object by depositing at least one agent onto a layer of powdered build material and 2) forms a 3D printed container and a 3D printed rupture device. The 3D printed container and 3D printed rupture device form a 3D printed container structure. The additive manufacturing system also includes a payload distributor to place a payload in the container structure and a controller to control additive manufacturing and payload distribution.

Such systems and methods 1) provide for a delayed release of a payload from a 3D printed object; 2) provide specific placement of the container structures forming a part of the 3D printed object; and 3) facilitate customization of the conditions that lead to structure rupture. However, it is contemplated that the systems and methods disclosed herein may address other matters and deficiencies in a number of technical areas.

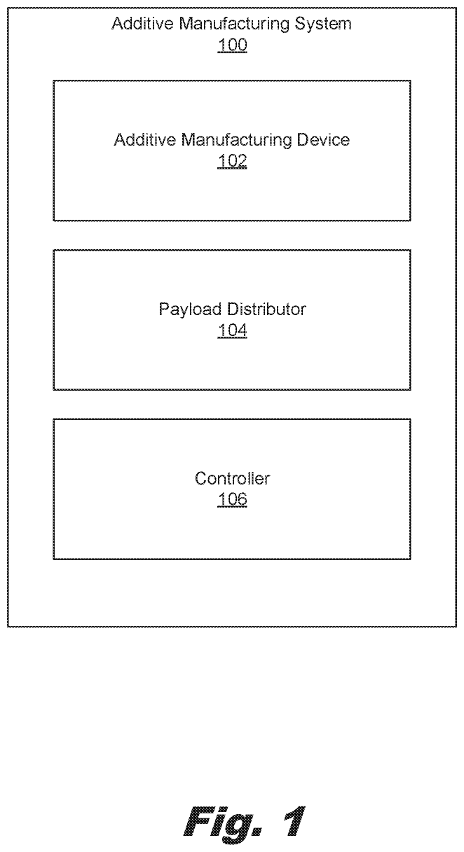

Turning now to the figures, FIG. 1 is a block diagram of an additive manufacturing system (100) for forming 3D printed objects and 3D printed container structures, according to an example of the principles described herein. The additive manufacturing system (100) includes an additive manufacturing device (102) to form a three-dimensional (3D) printed object. As described above, a 3D printed object may be formed using any variety of additive manufacturing devices (102) including a fusing-agent based system, or a system where a “green” part is passed to a sintering device to sinter particles together. The additive manufacturing device (102) may also be non-agent-based systems such as a selective laser sintering device, a selective laser melting device, a fused deposition modelling device, and a stereolithographic device.

The additive manufacturing device (102) also forms a container structure to form part of the 3D printed object. In some examples, the container structure may be enclosed within the 3D printed object. In others, the container structure may be on a surface of the 3D printed object. In other words, the container structure may form any part of the 3D printed object. That is, as a sub-part of a 3D printed object, there may be formed another 3D printed structure, specifically, a 3D printed container structure that may be a hollow structure filled with a payload. The container structure is to expel a payload when a predetermined condition is met. The predetermined condition may be of a variety of types. For example, the predetermined condition may be a pressure condition, an electrical condition, or a temperature condition. In some examples, the predetermined condition may be met following additive manufacturing. However, in other examples, the predetermined condition may be met during additive manufacturing.

As a specific example, the container structure may expel the payload when a certain pressure is exerted on the container structure. For example, when a user's foot is placed on a mat, the pressure of the user's foot may cause the container structure to rupture, thereby expelling its contents. In some examples, the predetermined conditions may cause the container structure to rupture. For example, a rupture device may pierce a container causing the container to rupture. In other examples, the container structure may remain intact while expelling.

As a specific example, a container structure may have a lattice structure that traps something inside, for example physical particles having a dimension slightly greater than the openings in the lattice. Accordingly, when pressure is applied, the lattice deforms such that some of those holes will get bigger if the cage is stretched (or compressed) in an appropriate dimension. Enlarging a hole in the containing cage would allow (at least some of) the payload to escape. This occurs by distorting the cage, but not rupturing it. After release, the cage may optionally be restored to original conditions. Accordingly, in this example, a payload is released without rupturing the container structure. Thus, the formed container structure may be re-used to expel a payload multiple times. Accordingly, in this example, the additive manufacturing device (102) forms a container structure to expel contents, but not rupture.

In other examples, the predetermined condition is an electrical condition. For example, when a voltage of a predetermined value is applied to the container structure it ruptures. In yet another example, the predetermined condition may be a temperature condition. For example, the container structure may include a bi-metal strip embedded in the container structure such that when heat is applied, the different metals of the bi-metal strip expand differently, changing the shape of the bi-metal strip, thus causing a rupture in the container structure.

The additive manufacturing system (100) also includes a payload distributor (104) to place the payload in the container structure. The payload may be of a variety of types. For example, the payload may include raw build material or doped build material. In another example, the payload may be a colored build material. In yet another example, the payload may be a liquid including, but not limited to an aroma and/or therapeutic compounds. In other examples, the payload may alter the characteristics of the surrounding material. For example, the payload may be a compound that heals a part or changes a stiffness of the surrounding material. For example, the payload may be an adhesive. In one particular example, the adhesive may be a 2-part epoxy-style resin-catalyst with each component stored in a different sub-chamber of the container structure. As the sub-chambers are ruptured, the resin and catalyst mix and harden. In either case, i.e., a one part adhesive that reacts upon contact with air or a two-part epoxy mixture, on release these components may affect part stiffness and/or may staunch an expanding crack.

As yet another example, the payload may be a physical structure such as an electronic circuit component. While specific reference is made to particular payloads, the container structure may hold different types of payloads of a variety of types.

The payload distributor (104) may take a variety of forms. For example, the payload distributor (104) may be an agent distributor that deposits a component such as raw powder build material, a liquid, a doping agent, and/or coloring agent into the container structure. In another example, the payload distributor (104) may be a placement device. For example, in the case the payload is an electronic hardware component, the placement device may include a suction cup. A suction device applies suction to the suction cup to retrieve the electronic hardware component. In this example, the suction cup is moved via a gantry over an open container structure, positioned, and the suction is removed such that the component is placed in the container structure.

The system (100) also includes a controller (106) to control the formation of the 3D printed object and the container structure. That is, the controller (106) instructs the additive manufacturing device (102) to form the 3D printed object and the 3D printed container structure based on print information received from a host device. As described above, the information may include things such as desired raw materials for the 3D printed object, environmental conditions to maintain during additive manufacturing, and a physical layout of the object relative to other objects during additive manufacturing, among others. Accordingly, the controller (106) controls the various components of the additive manufacturing device (102) based on this information.

The controller (106) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (106) cause the controller (106) to implement at least the functionality of interrupting printing and resuming printing as described below.

Additionally, during operation, the controller (106) may serve to provide instructions to a number of other devices associated with the additive manufacturing system (100) to accomplish the functionality of the additive manufacturing system (100). Specifically, in a fusing agent-based system, the controller (106) may direct the build material distributor to add a layer of build material. Further, the controller (106) may send instructions to direct the printhead to selectively deposit the agent onto the surface of a layer of the build material. The controller (106) may also direct the printhead to eject the agent at specific locations to form a 3D printed object slice.

The controller (106) may also control the payload distributor (104) during additive manufacturing. That is, in one particular example, the controller (106) may interrupt formation of the 3D printed object to place a payload. In this example, the controller (106) interrupts formation to facilitate such a placement. In some examples, interrupting the additive manufacturing process includes deactivating the build material distributor and any build material hardening device. In the example where the build material distributor and agent distributor are placed on scanning carriage(s), the controller (106) also moves these scanning carriage(s) away from the component such that an object may be placed.

After the operation that is to be carried out during the pause is complete, the controller (106) resumes additive manufacturing. That is, the controller (106) selectively re-activates the build material distributor and a hardening device to continue the operation of sequentially operating to form slices of a 3D printed object.

Upon resumption, the additive manufacturing device (102), can be tuned following placement of the payload. Note that during additive manufacturing prior to the placement of the payload and during additive manufacturing following placement of the payload, the controller (106) may alter the operation of the build material distributor and/or any device that hardens the build material. For example, the controller (106) may alter the fusing agent distribution to ensure a proper adhesion of a portion of the container structure formed before placement of the payload, and the portion of the container structure formed after placement of the payload.

Accordingly, the present specification describes a system (100) wherein a container structure is integrated as part of, either embedded in or simply formed on a surface of, a 3D printed object and that expels a payload therein when a certain predetermined condition is met. In some examples, the release of the payload may result in an optical effect. For example, the payload may be a colored liquid/powder, thus providing an indication of which container structures have been ruptured. Such may be the case as described above in a 3D pressure-sensitive floormat where a colored liquid/powder provides an indication of which container structures have been ruptured thus resulting in a pressure map of the foot. In some examples, what happens when a payload is released may be a non-optical effect. For example, the payload may change a conductivity in an electrical circuit element or deliver an aroma to a nearby user.

In one specific example, such a 3D printed object may be used to encode information. The ability to encode information is a part of a security solution. The present additive manufacturing system (100) allows a 3D printed object to carry encoded information in a manner that is encrypted and/or tamper evident. For example, in this case, the additive manufacturing device (102) may form container structures with different dopings of payload materials. In a particular example, different container structures may carry payloads doped with cyan, magenta, yellow, or black pigment particles. Accordingly, there are four unique payloads, so each container structure may encode two bits of information. In a particular example of securely encoding information, in an opaque build material such as fused polyamide 12 (PA12) surrounds the payload, there may not be a simple way to detect the different doping of materials inside opaque container structures. Accordingly, if validation is necessary, the container strictures are ruptured and contents examined to see if they match an expected pattern. Accordingly, the present container structure layout may be used to impart a hidden, but readable, serial number, or other information, inside a part.

As yet another example conductive or magnetic compounds may be included in the payload. By encapsulating conductive, or magnetic compounds in the container structure, the container structures could be detected by non-optical means. In such an example, a ruptured container structure may have a different signal profile than a non-ruptured container structure, thereby providing a means to read information encoded in ruptured vs. non-ruptured container structures.

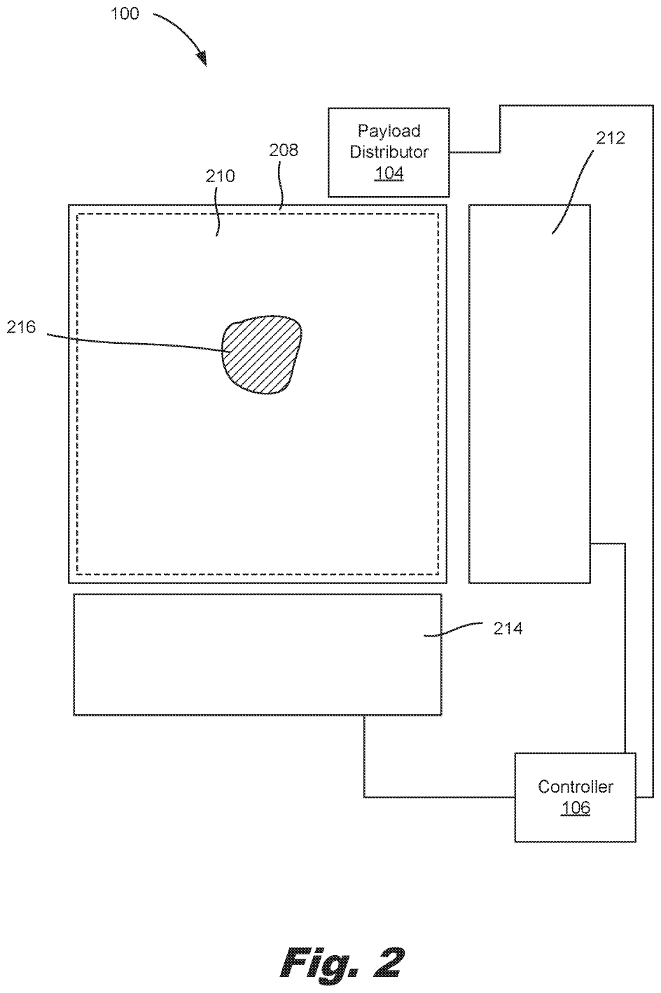

FIG. 2 is a simplified top view of an additive manufacturing system (100) for forming 3D printed objects and 3D printed container structures, according to an example of the principles described herein. In general, apparatuses for generating three-dimensional objects may be referred to as additive manufacturing systems (100). The additive manufacturing system (100) described herein may correspond to three-dimensional printing systems, which may also be referred to as three-dimensional printers. The additive manufacturing system (100) includes an additive manufacturing device (FIG. 1, 102). An additive manufacturing device (FIG. 1, 102) may use a variety of operations. For example, the additive manufacturing device (FIG. 1, 102) may be a fusing agent-based device (as depicted in FIG. 2), a binding-agent based device, a selective laser sintering device, or a selective laser melting device. While FIG. 2 depicts a specific example of an agent-based device, the additive manufacturing device (FIG. 1, 102) may be any of the above-mentioned devices or another type of additive manufacturing device.

In an example of an additive manufacturing process, a layer of build material may be formed in a build area (210). As used in the present specification and in the appended claims, the term “build area” refers to an area of space wherein the 3D printed object (216) is formed. The build area (210) may refer to a space bounded by a bed (208). In FIG. 2 and others the 3D printed object (216) is indicated in a hashed fill to distinguish the fused nature of the powder build material as compared to the unfused powder build material that surrounds it.

In the additive manufacturing process, any number of functional agents may be deposited on the layer of build material. One such example is a fusing agent that facilitates the hardening of the powder build material. In this specific example, the fusing agent may be selectively distributed on the layer of build material in a pattern of a layer of a three-dimensional object. An energy source may temporarily apply energy to the layer of build material. The energy can be absorbed selectively into patterned areas formed by the fusing agent, while blank areas that have no fusing agent absorb less applied energy. This leads to selected zones of a layer of build material selectively fusing together. This process is then repeated, for multiple layers, until a complete physical object has been formed. Accordingly, as used herein, a build layer may refer to a layer of build material formed in a build area (210) upon which the functional agent may be distributed and/or energy may be applied.

Additional layers may be formed and the operations described above may be performed for each layer to thereby generate a three-dimensional printed object (216). Sequentially layering and fusing portions of layers of build material on top of previous layers may facilitate generation of the three-dimensional object (216). The layer-by-layer formation of a three-dimensional object (216) may be referred to as a layer-wise additive manufacturing process.

In another example, a binding agent is selectively deposited on to particular areas of the build material to adhere select areas of the build material together. This is again done in a layer-wise fashion. After all layers of the 3D printed object (216) have been formed, and solvents in the binding agent removed, a “green” part, defined by regions where binding agent is holding together build material, is passed to a sintering furnace to sinter build material particles together.

In one example, the additive manufacturing system (100) includes a build material distributor (214) to successively deposit layers of the build material in the build area (210). Each layer of the build material that is fused in the bed forms a slice of the 3D printed object (216) such that multiple layers of fused build material form the entire 3D printed object (216). The build material distributor (214) may acquire build material from build material supply receptacles, and deposit such acquired material as a layer in the bed (208), which layer may be deposited on top of other layers of build material already processed that reside in the bed (208).

In some examples, the build material distributor (214) may be coupled to a scanning carriage. In operation, the build material distributor (214) places build material in the build area (210) as the scanning carriage moves over the build area (210) along the scanning axis. While FIG. 2 depicts the build material distributor (214) as being orthogonal to the agent distributor (212), in some examples the build material distributor (214) may be in line with the agent distributor (212).

The additive manufacturing system (100) includes an agent distributor (212) to form the 3D printed object (216) and the 3D printed container structure which includes a 3D printed container and a 3D printed rupture device. The agent distributor (212) does so by depositing at least one agent onto a layer of powdered build material.

In some examples, an agent distributor (212) includes at least one liquid ejection device to distribute a functional agent onto the layers of build material. A liquid ejection device may include at least one printhead (e.g., a thermal ejection based printhead, a piezoelectric ejection based printhead, etc.). In some examples, the agent distributor (212) is coupled to a scanning carriage, and the scanning carriage moves along a scanning axis over the build area (210). In one example, printheads that are used in inkjet printing devices may be used as an agent distributor (212). In this example, the functional agent may be a printing liquid. In other examples, an agent distributor (212) may include other types of liquid ejection devices that selectively eject small volumes of liquid.

As described above, the agent distributor (212) may distribute a variety of agents. One specific example of an agent is a fusing agent, which increases the energy absorption of portions of the build material that receive the fusing agent to selectively solidify portions of a layer of powdered build material.

The agent distributor (212) may deposit other agents as well. For example, the agent distributor (212) may distribute a detailing agent, into non-fused regions near the 3D printed object (216). Doing so sharpens the resolution of the 3D printed object (216) and the container structure formed therein and provides cooling to selected regions of the powdered build material. In one particular example, the detailing agent may be applied to the build material to be trapped inside the container structure. Doing so may keep this build material from fusing due to thermal bleeding as the remaining portions of the container structure are formed and fused.

While specific reference is made to agent-based systems, the additive manufacturing system (100) as described herein may be implemented in non-agent-based systems such as selective laser sintering and selective laser melting additive manufacturing processes.

FIG. 2 also depicts a payload distributor (104) to place a payload in the container structure. The payload distributor (104) may take a variety of forms and in one example is a placement device to place a physical device in the container structure. That is, the placement device may take a component from a repository, move it to a desired location over the 3D printed object and place it. In some examples, the placement device is positioned on a scanning carriage that moves across the bed (210) of the additive manufacturing system (100).

In one particular example, the placement device includes multi-axis actuators, a suction cup, and a controllable vacuum source. In this example, a suction cup, via a suction force, collects the component. The actuators and connector arm can be employed to move the component vertically and horizontally to position the component appropriately. While particular reference is made to one example of a placement device, other types of placement devices may be implemented in accordance with the principles described herein.

In other examples, the payload distributor (104) may be an agent distributor such as a liquid inkjet distributor similar to the agent distributor (212) or may be a powder material distributor as the build material distributor (214).

FIG. 2 also depicts the controller (106). As described above, the controller (106) instructs the additive manufacturing device (FIG. 1, 102), i.e., the build material distributor (214) and the agent distributor (212), to form the 3D printed object (216) and 3D printed container structure based on the 3D print information. In some examples, such control manifests as interrupting and resuming additive manufacturing to allow for placement of the payload.

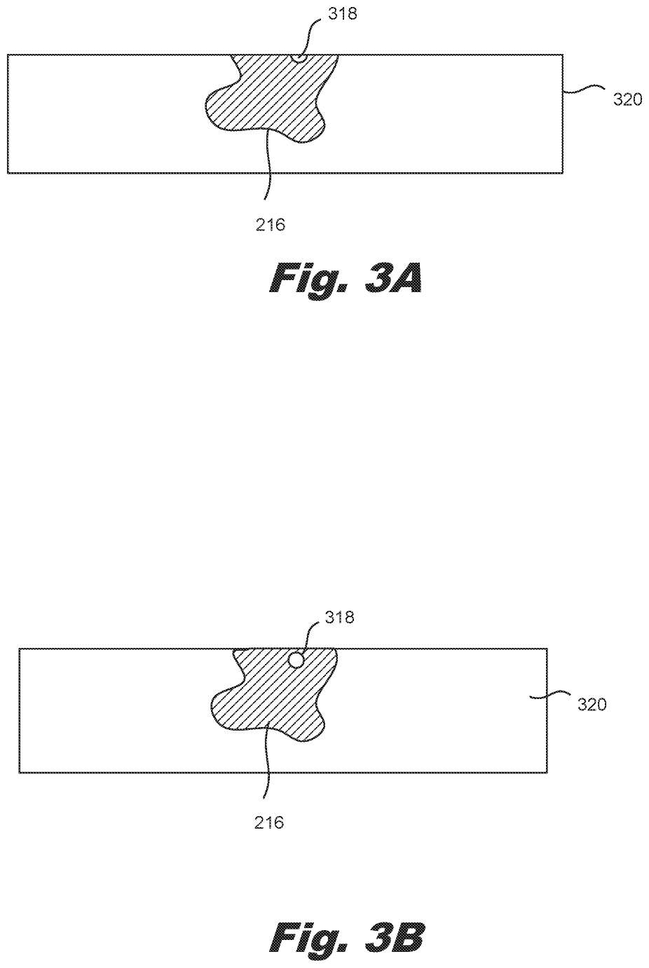

FIGS. 3A and 3B are side views of an additive manufacturing bed (FIG. 2, 208) for forming 3D printed objects (216) and 3D printed container structures (318), according to an example of the principles described herein. As described above, the additive manufacturing operation includes the sequential deposition of layers of a powdered build material (320) that are selectively hardened in a number of ways to form a 3D printed object (216). In the example depicted herein, at a certain point in time, depicted in FIG. 3A after a portion of the container structure (318) has been formed, the controller (FIG. 1, 106) interrupts the additive manufacturing process by pausing the build material distribution and any agent distribution, and a payload distributor (FIG. 1, 104) places a payload within the borders defining the 3D printed object (216) to ultimately be embedded therein or thereon.

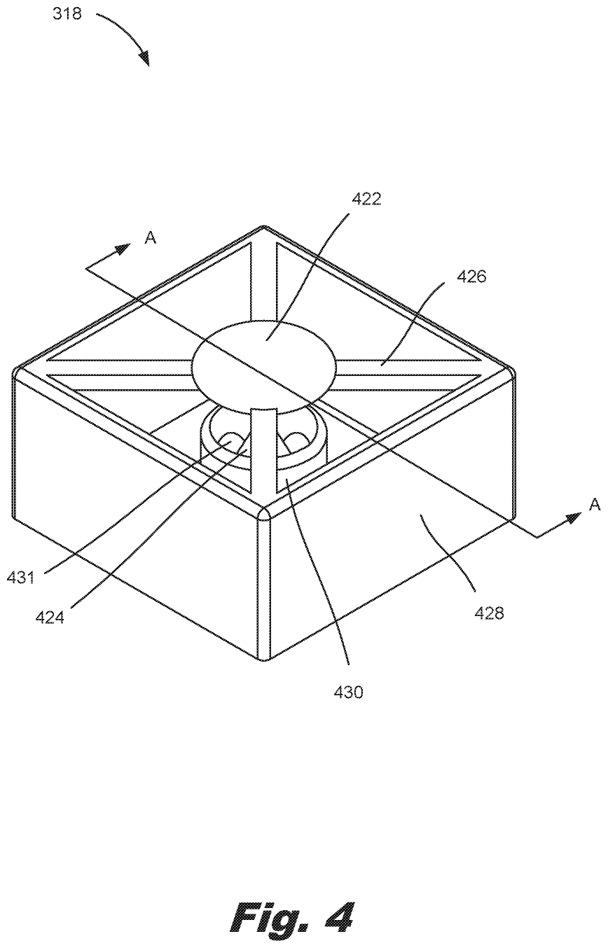

FIG. 4 is an isometric view of a 3D printed container structure (318), according to an example of the principles described herein. In this example, the container structure (318) includes a container (422) and a rupture device (424). In some examples, the 3D printed container structure (318) depicted herein may be fabricated in a single build cycle. Given the openings in the top portion of the container structure (318) surrounding the container (422), residual material can escape and/or be removed in a cleaning process. In other examples, residual material outside the container (422) may be trapped inside the container structure (318). However, the container structure (318) will function even with the residual unfused build material contained therein as unfused material is not solid and may be displaced by movement of the container (422).

The rupture device (424) may be of varying types. For example, the rupture device (424) may be a mechanical rupture device, an electrical rupture device, or a thermal rupture device. FIGS. 4, 5A, 5B, 6A, and 6B depict a specific example, where a pressure-driven mechanical puncture apparatus releases the material from the container (422). That is, the container (422) may be a sac or other hollow receptacle that has been filled with a payload. A pressure may physically move either the container (422) or the rupture device (424) such that the rupture device punctures the container (422).

In some examples, the container structure (318) may also include a spring device (426). In the example depicted in FIG. 4, the spring device (426) refers to the material that suspends the container (422). As a pressure is applied to the container (422), the spring device (426) may deflect and increasingly resist the applied pressure. If the applied pressure is sufficiently large, it will overcome resistance of the spring and force the container (422) against the rupture device (424).

A rupture threshold of the 3D printed container structure (318) may be adjusted by altering characteristics of the container structure (318), specifically the characteristics of the rupture device (424), the spring device (426), and container (422). As a specific example, the container (422) may be made with thicker walls such that rupture requires a larger pressure. As another example, the height of the rupture device (424) may be similarly adjusted to increase the distance the applied force needs to move the container (422) to effectuate a rupture. That is, if there is a greater distance between the rupture device (424) and the container (422) due to decreasing the height of the protrusion, greater force is required to overcome this increase in height. Thus, the container structure (318) may be customized to rupture at a variety of different thresholds. Put another way, the container structure characteristics affect puncture force. As another example, the container (422) shell could be doped with material changing the puncture force resistance, or melting point. In other words, while a few specific alterations are described which affect the puncture threshold of the container (422), there are a variety of different characteristics that could be altered to affect the condition(s) at which the payload is expelled.

While specific reference is made to a mechanical rupture device (424) other types of rupture devices (424) may also be implemented. For example, the rupture device (424) may be an electrical rupture device (424). That is, the rupture device (424) may include an electrically resistive element to rupture the container (422). In this example, application of electrical energy causes rupture. In one particular example, voxels may be made conductive by doping them with metal particles delivered via suspension in ink jetted liquids. Accordingly, a resistor may be made via this or another process and placed adjacent to, or integral with, the container (422) shell. When a sufficient current is passed through the resistor, it will get hot enough to mechanically compromise the container (422), causing release of contents.

In another example, the rupture device (424) is a thermal rupture device (424). In this example, heating of the container structure (318) causes payload release. For example, a payload may be released if the 3D printed object (FIG. 2, 216) is left on the dash of a hot car. This may be done via a porous container (422) and material inside that has volatile compounds that vaporize at a threshold temperature and escape.

In some examples, the container structure (318) includes a payload receptacle (428) to capture the expelled payload. For example, a user may want to capture the payload for subsequent analysis. The payload receptacle (428) facilitates such a collection for subsequent analysis. While FIG. 4 depicts a particular configuration of a container structure (318), other structures are possible as well.

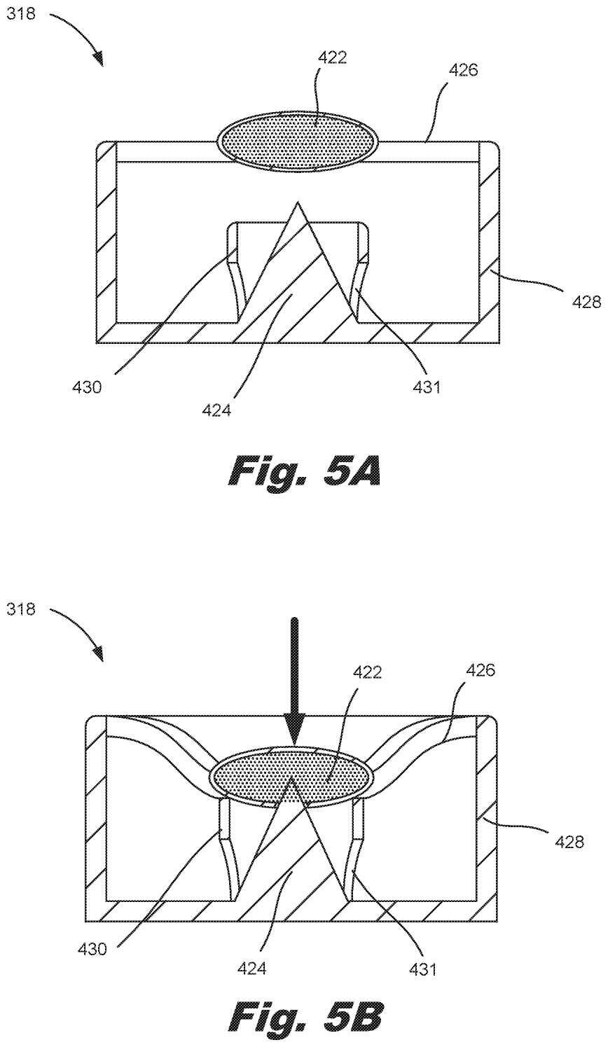

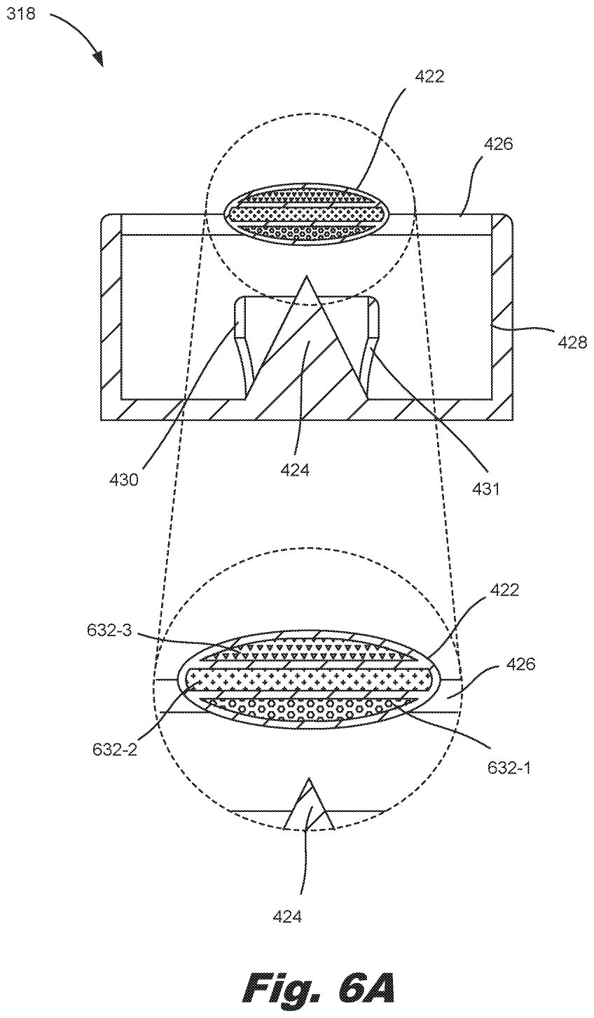

In the examples depicted in FIGS. 4-5B, the container structure (318) further includes a stop collar (430) to limit the vertical travel of the container (422) after a rupture event. This may be desirable in many applications. For example, in the foot pressure application, if the spring device (430) were to deflect too much, the rupture device (424) may contact a user's foot causing discomfort or other injury.

In some examples, a portion of the released payload may become trapped inside the stop collar (530) following rupture, which may make the effects of rupture more difficult to see. Accordingly, in some examples, the stop collar (430) includes holes (431) around the base of the stop collar (530). Accordingly, through these holes (431) released contents may escape from the inside of the stop collar (530) and spill out over the full floor of the payload receptacle (428) to make it easier to see/detect a past rupture event.

FIGS. 5A and 5B are cross sections of a 3D printed container structure (318), according to an example of the principles described herein. Specifically, FIG. 5A depicts a non-ruptured 3D printed container structure (318) and FIG. 5B depicts a ruptured 3D printed container structure (318) taken along the line A-A in FIG. 4. As depicted in FIG. 5A, the rupture device (424) which may or may not be in contact with the container (422) has not ruptured the container (422).

On application of pressure as indicated by the arrow in FIG. 5B, the container (422) is deflected towards the rupture device (424) based on action of the spring device (426). If the pressure is large enough, the container (422) comes into contact with the rupture device (424) and ruptures, releasing the payload disposed therein. As described above, the container structure (318) may include a payload receptacle (428) to contain the payload. In some examples, the receptacle (428) is translucent, allowing direct optical readability. In an example where the receptacle (428) is opaque, the container structure (318) may be opened to allowing inspection of the box. In this example, finding powder in the receptacle (428) may indicate a rupture-inducing pressure (or excursion) event occurred in the past. In some examples, the walls of the receptacle (428) may extend above the height of the container (422). In this example, a compliant sheet, which may be transparent, may be placed over the container structure (318).

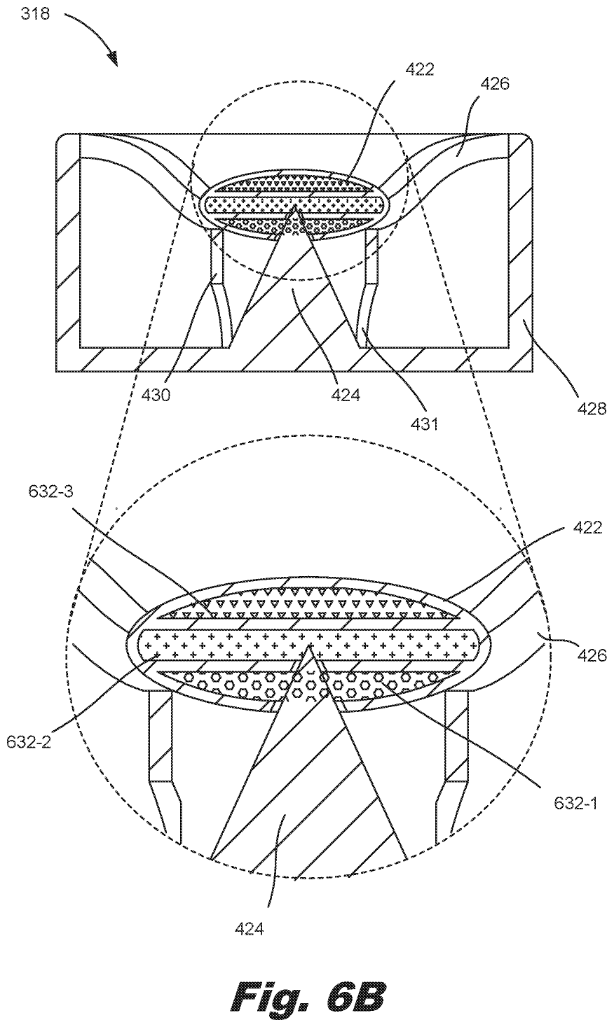

FIGS. 6A and 6B are cross sections of a 3D printed container structure, according to another example of the principles described herein. Specifically, FIG. 6A depicts a cross-section with an unruptured container (422) and FIG. 6B depicts a cross-section with a ruptured container (422). As with the previous example, when a force is applied, the spring device (426) deflects such that the protruding device (424) pierces the container (422). However, in this example, the container (422) is formed so as to have various chambers (632) to expel a respective payload when different predetermined conditions are met. That is, the additive manufacturing device (FIG. 1, 102) may form the container structure (FIG. 3, 318). with a multi-chamber (632) container (422)

In this example, each of the different chambers (632-1, 632-2, 632-3) rupture at different pressure thresholds. Accordingly, using such a multi-chamber (632) container (422), different payloads could be released depending on different conditions. As a specific example, a first chamber (632-1) may be filled with cyan-stained build material, a second chamber (632-2) may be filled with a magenta-stained build material, and a third chamber (632-3) may be filled with a yellow-stained build material. When a first pressure threshold is crossed, the cyan material would be released, then if a second threshold is exceeded, the magenta material is released, and finally when an even larger third pressure threshold is exceeded, yellow build material is released. Such a multi-chamber (632) container (422) allows for additional capabilities to be contained in a single container structure (318).

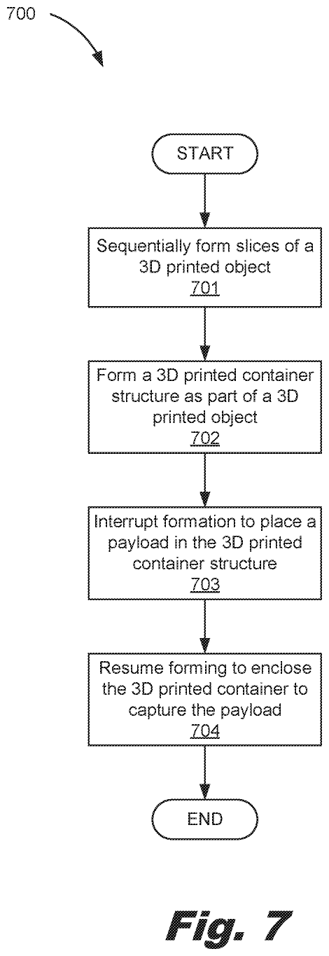

FIG. 7 is a flow chart of a method (700) for forming 3D printed objects (FIG. 2, 216) and 3D printed container structures (FIG. 3, 318), according to an example of the principles described herein. As described above, additive manufacturing involves the layer-wise deposition of build material and hardening/curing/sintering/fusing of certain portions of that layer to form a slice of a 3D printed object (FIG. 2, 216). Accordingly, in this example, the method (700) includes sequentially forming (block 701) slices of a 3D printed object (FIG. 2, 216). This includes sequential activation, per slice, of a build material distributor (FIG. 2, 214) and an agent distributor (FIG. 2, 212) and the scanning carriages to which they may be coupled so that each distribute its respective composition across the surface.

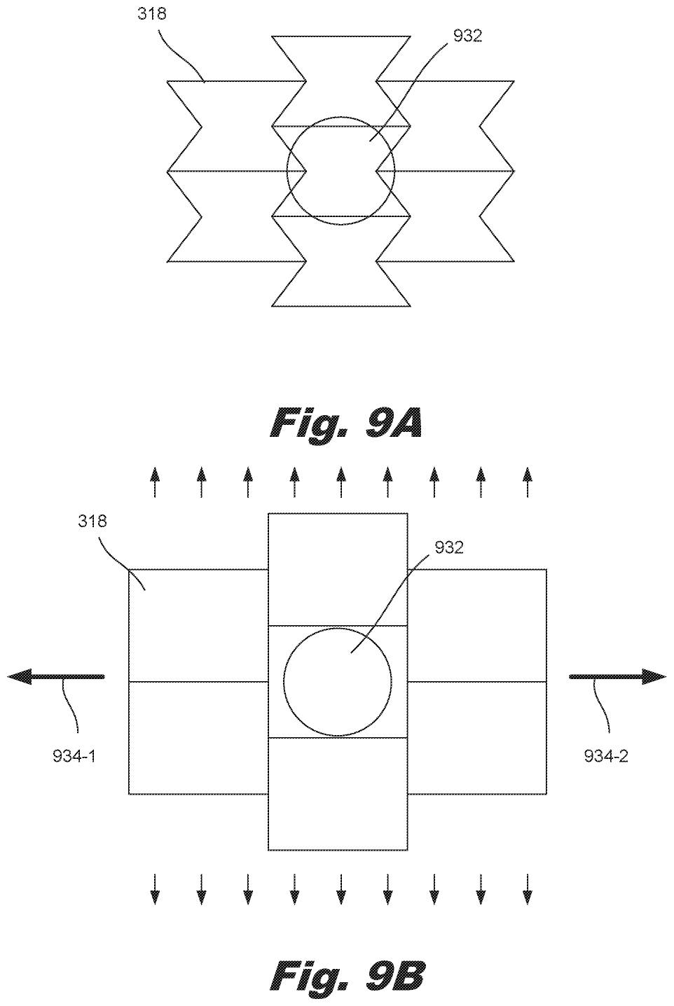

In addition to sequentially forming (block 701) slices of a 3D printed object (FIG. 2, 216), the additive manufacturing device (FIG. 1, 102) also forms (block 702) a 3D printed container structure (FIG. 3, 318) as part of a body of the 3D printed object (FIG. 2, 216). This may also include a sequential activation, per slice, of a build material distributor (FIG. 2, 214) and an agent distributor (FIG. 2, 212) to form the container structure (FIG. 3, 318). As described the container structure (FIG. 3, 318) may take many forms, such as that depicted in FIGS. 4-6 or a lattice structure as depicted in FIGS. 9A and 9B below. That is, the container structure (FIG. 3, 318) may take any form so long as it holds a payload and may be manipulated to release that payload. The controller (FIG. 1, 106) may control the additive manufacturing device (FIG. 1, 102) such that the 3D printed container structure (FIG. 3, 316) ruptures at a predetermined pressure. This may include altering dimensions of any one of the features that make up the container structure (FIG. 3, 318), specifically the container (FIG. 4, 422) and rupture device (FIG. 4, 424).

In some examples, a detailing agent may be disposed around the container structure (FIG. 3, 3 18). Specifically, the detailing agent may be applied around surfaces of the 3D printed container structure (FIG. 3, 318) to ensure that any fusing of the container structure (FIG. 3, 318) does not fuse or otherwise affect the payload. In some examples, the detailing agent may be applied to the payload itself so as to prevent fusing of the payload as remaining portions of the container (FIG. 4, 422) are formed.

At some point during printing, the controller (FIG. 1, 106) interrupts (block 703) the formation of the 3D printed object (FIG. 2, 216) and 3D printed container (FIG. 3, 318) for placement a payload into the 3D printed structure (FIG. 3, 318). During this interruption, the payload distributor (FIG. 1, 104) which may take a variety of forms including an agent distributor or a physical pick and place device, places the payload inside the 3D printed container structure (FIG. 3, 318).

Once the payload is placed, the forming of slices of the 3D printed object (FIG. 2, 216) is resumed (block 704). Resumption of additive manufacturing process also encloses the container structure (FIG. 3, 318) which captures the payload in the 3D printed container structure (FIG. 3, 318). In other words, the present method (700) provides for the inclusion in a 3D printed object (FIG. 2, 216) a container structure (FIG. 3, 318) that holds a payload. In some examples, the container structure (FIG. 3, 318) is rupturable or otherwise deformable to allow the contents therein to be expelled.

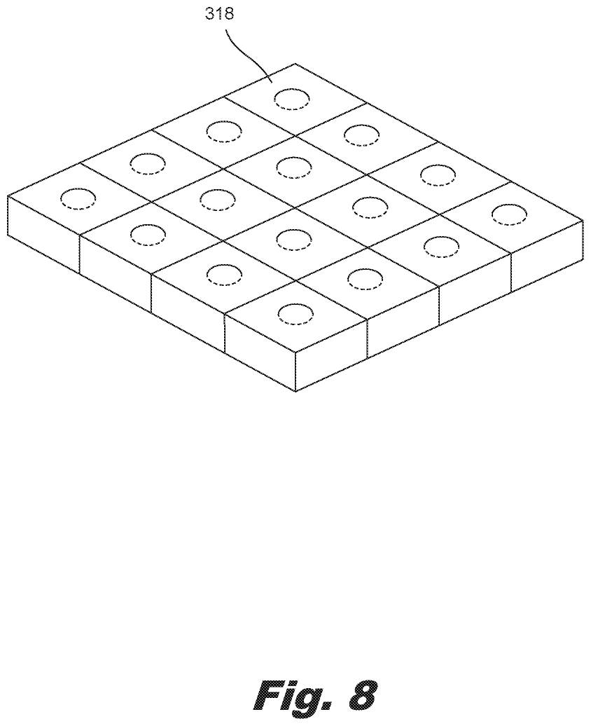

FIG. 8 is an isometric view of an array of 3D printed container structures (318) in a 3D printed object (FIG. 2, 216), according to an example of the principles described herein. In some examples, an array of 3D printed container structures (318) may be formed. That is, the additive manufacturing device (FIG. 1, 102) forms multiple container structures (318) and may tile them across a surface. In this example, the payload distributor (FIG. 1, 104) places a payload into multiple, and in some cases all of the multiple containers (FIG. 4, 422) of the container structures (318). For simplicity, a single container structure (318) is indicated with a reference number. In such an example a pattern of which container structures (318) are loaded with a payload may be used to encode information or provide authentication to the 3D printed object (FIG. 2, 216). For example, a manufacturer may decide not to place payloads in certain container structures (318) and to load others. The loaded/non-loaded state could be detected later by various operations, including rupturing container structures (318).

As described above, where pressure is a condition upon which a container structure (318) ruptures and the contents therein indicate a pressure threshold was exceeded at that location, an array of container structures (318) may provide a map of applied pressure across a surface. As a specific example, an array of container structures (318) may form a floormat on which a user may stand. The pressure the user's foot exerts on the floormat may rupture some of the container structures (318) which may expel a visible colored liquid or colored powder. Accordingly, a visual indication of pressure levels is indicated on the floormat. Note that while FIG. 8 and the example provided above indicate a planar surface, the surface could be complex, such as the surface of a handle. In this example, the array of container structures (318) may be used to measure grasping pressures.

In one particular example, different of the multiple container structures (318) are formed to have different predetermined conditions at which point they release their payload. For example, some container structures (318) may rupture at five pounds per square inch while others do not rupture until ten pounds per square inch. As described above, this may be carried out by altering characteristics of the respective container structures (318). In one particular example, the payload of a container structure (318) may relate to the rupture threshold. For example, a red colored liquid may be included in a container structure (318) which ruptures at 5 pounds per square inch and a blue colored liquid may be included in a container structure (318) which ruptures at 10 pounds per square inch. Accordingly, a resultant array may not only indicate those areas that see a certain pressure, but indicate a value associated with the pressure exerted.

In some examples, the container structures (318) may be of varying types, meaning they have different physical structures or contain different payloads. For example, some container structures (318) may include information for security, while others would trigger a mechanical pressure threshold was exceeded.

FIGS. 9A and 9B depict a 3D printed container structure (318), according to an example of the principles described herein. As described above, in some examples the container structure (318) may allow for release of the payload (932) while not rupturing. Accordingly, in this example, a portion of the payload (932) may be released, thus facilitating a repetitive, as opposed to one time, release of the payload (932).

As a specific example, a container structure (318) may have a lattice structure as depicted in FIG. 9A that traps a payload (932) inside, for example on account of a payload (932) being made up of physical particles having a dimension slightly greater than the openings in the lattice.

Accordingly, when force is applied as indicated by the arrows (934), the holes of the lattice may get bigger as the container structure (318) is stretched (or compressed). As depicted in FIG. 9B, enlarging a hole in the container structure (318) may allow at least a portion of the payload (932) to escape. This occurs by distorting the container structure (318), but not rupturing it. Accordingly, after release, the container structure (318) may optionally be restored to its original state in FIG. 9A to retain whatever payload (932) remains therein.

As described above, an array of these types of container structures (318) may be tiled across a surface such that one payload (932) is released under certain force conditions with an additional payload (932) being release with a higher force condition.

As yet a further, a single container structure (318) may be deformable to different degrees. For example, a single container structure (318) may expand to one particular pore size which allows a payload (932) of a first size to be released, followed by a larger expansion under higher force which allows for another payload (932) of a second size, but still captured in the container structure (318), to be released.

Such an expandable container structure (318) may allow for filling the container structure (318) following formation of the container structure (318). That is, as previously described, a container structure (318) may be partially formed, after which it is filled and completed. However, with a reversible structure, the payload distributor (FIG. 1, 104) may place the payload following formation of the 3D printed object (FIG. 2, 216) and the 3D printed container structure (318). As one specific example, on a reversible container structure (318), a container structure (318) with an enlargeable lattice structure could, when features are stretched wider, allow entry of a payload. For example, a container structure (318) with openings being less than 1 mm in diameter without any force applied, may be stretched so openings in the container structure (318) are at least 1.5 mm in diameter. Accordingly, if the tiled array or 3D printed object (FIG. 2, 216) that is made up of 3D printed container structures (FIG. 3, 318) were dipped in a solution with suspended 1 mm diameter particles, those particles could enter into the container structure (318). Upon release of the force those particles would be trapped on account of the diameter of the particles (1 mm) being greater than the openings (less than 1 mm).

In some examples, if a container structure (318) is sponge-like, it can pull in liquids by capillary action, and the liquid can subsequently be released by squeezing and/or by elevating temperature. In another example, a user may soak a 3D printed object (FIG. 2, 216) in a solution that causes material to be deposited either into or onto elements of the 3D printed object (FIG. 2, 216). For example, if a 3D printed object (FIG. 2, 216) is dipped in a salt water solution and removed, when that solution dries, a residue of salt will be left on accessible surfaces of the 3D printed object (FIG. 2, 216) while others are introduced into the container structures (FIG. 3, 318). The residue may be left on non-structure surfaces can be cleaned or, in some cases, simply ignored and left in place.

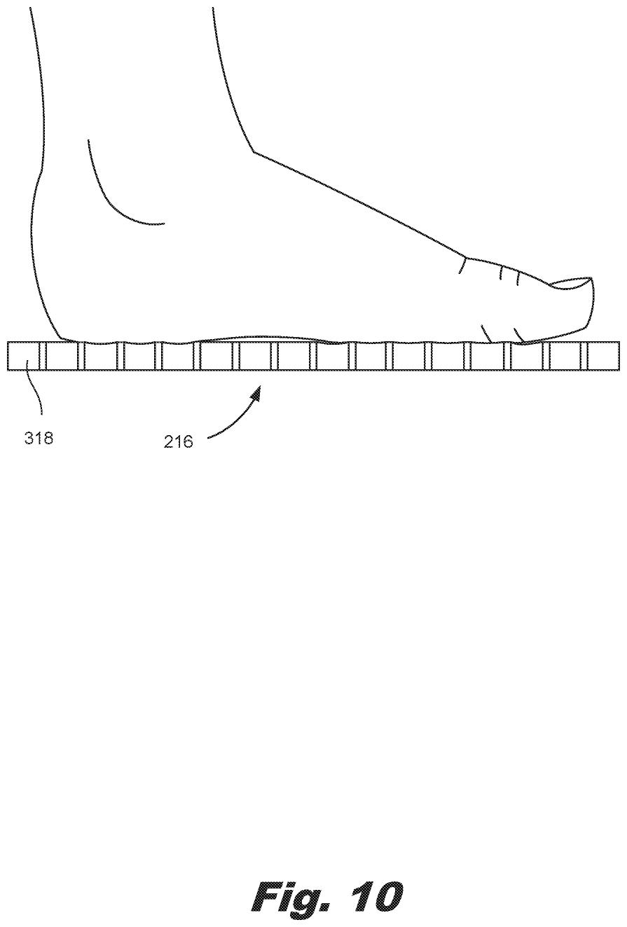

FIG. 10 depicts a 3D printed object (216) with an array of 3D printed container structures (318), according to another example of the principles described herein. Specifically, FIG. 10 depicts a 3D printed object (216) that includes a tiled array of 3D printed container structures (318) separated from one another. As described above, based on the pressure exerted on the 3D printed object (216) based on the contours of a user's foot, different of the container structures (318) may rupture and spill their payload. As described above different colored powders or a colored liquid may be used in each container structure (318) to indicate local pressures at different locations under the user's foot.

Such systems and methods 1) provide for a delayed release of a payload from a 3D printed object; 2) provide specific placement of the container structures form part of the 3D printed object; and 3) facilitate customization of the conditions that lead to structure rupture. However, it is contemplated that the systems and methods disclosed herein may address other matters and deficiencies in a number of technical areas.

What is claimed is:

1. An additive manufacturing system, comprising:
an additive manufacturing device to form:
a three-dimensional (3D) printed object; and
a container structure to form part of the 3D printed object, the container structure to expel a payload when a predetermined condition is met;
a payload distributor to place the payload in the container structure; and
a controller to control formation of the 3D printed object and the container structure.

2. The additive manufacturing system of claim 1, wherein the payload comprises at least one of:
raw build material;
doped build material;
a liquid;
colored build material; and
a hardware structure.

3. The additive manufacturing system of claim 1, wherein the payload distributor is selected from the group consisting of:
an agent distributor, and
a placement device.

4. The additive manufacturing system of claim 1, wherein:
the container structure comprises:
a container; and
a rupture device; and
the rupture device is at least one of:
a mechanical rupture device;
an electrical rupture device; and
a thermal rupture device.

5. The additive manufacturing system of claim 4, wherein:
the container is to deflect towards the rupture device; and
the rupture device comprises a protrusion to rupture the container.

6. The additive manufacturing system of claim 4, further comprising at least one of:
a stop collar; and
a payload receptacle.

7. The additive manufacturing system of claim 4, wherein the rupture device comprises an electrically resistive element to rupture the container.

8. The additive manufacturing system of claim 1, wherein:
the additive manufacturing device is to form multiple container structures; and
the payload distributor is to place a payload in more than one of the multiple container structures.

9. The additive manufacturing system of claim 8, wherein different of the multiple container structures are formed to have different predetermined conditions at which point they release their payload.

10. A method, comprising:
sequentially forming slices of a three-dimensional (3D) printed object;
forming a 3D printed container structure as a part of the 3D printed object, the 3D printed container structure to expel a payload when predetermined conditions are met;
interrupting the formation of the 3D printed object and 3D printed container structure to place the payload in the 3D printed container structure; and
resuming forming of slices of the 3D printed object to enclose the 3D printed container structure to capture the payload.

11. The method of claim 10, wherein forming a 3D printed container structure comprises forming a 3D printed container structure with various chambers to expel a respective payload when different predetermined conditions are met.

12. The method of claim 10, further comprising applying a detailing agent around surfaces of the 3D printed container structure.

13. An additive manufacturing system, comprising:
a build material distributor to deposit layers of powdered build material onto a bed;
an agent distributor to:
form a three-dimensional (3D) printed object by depositing at least one agent onto a layer of powdered build material; and
form a 3D printed container and a 3D printed rupture device, wherein the 3D printed container and 3D printed rupture device form a 3D printed container structure;
a payload distributor to place a payload in the container structure; and
a controller to control additive manufacturing and payload distribution.

14. The additive manufacturing system of claim 13, wherein the payload distributor places the payload following formation of the 3D printed object and the 3D printed container structure.

15. The additive manufacturing system of claim 13, wherein a rupture threshold of the 3D printed container structure is selected by adjusting characteristics of at least one of:
the 3D printed rupture device; and
the 3D printed container.
